(19) United States
(12) Patent Application Publication
(10) Pub. No.: US 2011/0259214 A1
(43) Pub. Date: Oct. 27, 2011

(54) Side Wall Platen Actuator for Trash Compactor

(75) Inventor: Don H. Nguyen, Fountain Valley, CA (US)

(73) Assignee: MAG Aerospace Industries, Inc., Carson, CA (US)

(21) Appl. No.: 13/094,434

(22) Filed: Apr. 26, 2011

Related U.S. Application Data
(60) Provisional application No. 61/343,260, filed on Apr. 26, 2010.

(51) Int. Cl. B30B 15/32

(52) U.S. Cl. 100/246; 100/35

(57) ABSTRACT

Embodiments of the present invention relate generally to a mechanically movable wall for use in a trash compactor.

This application claims the benefit of U.S. Provisional Application Ser. No. 61/343,260, filed Apr. 26, 2010 titled “Ramp Side Wall Platen Actuator,” the entire contents of which are hereby incorporated by reference.

### FIELD OF THE INVENTION

Embodiments of the present invention relate generally to a mechanically movable wall for use in a trash compactor.

### BACKGROUND

Collecting and disposing of trash in confined conditions, particularly on-board passenger transport vehicles, such as aircraft, trains, ships, buses, RVs, and other water or air travel vessels can be challenging. However, a good deal of rubbish is generated on such vehicles. For example, after in-flight beverage service, unused items are collected, which often includes drink cups, napkins, newspapers, food wrappers, tea bags, beverage cans, other packaging or non-consumable items and the like, food wastes, or any other type of disposable item that a passenger may consume or bring on-board.

Once collected, most trash is compacted by a trash compactor located in the galley area. This saves valuable space and allows more trash to be collected and stored. The compacting cycle typically uses a flat plunger or plate, called a platen, that is compressed from an upper portion of the compactor downwardly into the trash bin. The creates a good deal of pressure on the trash bin, which is typically a cardboard carton positioned inside the compactor unit. Once the compacting cycle has taken place and the trash is firmly compacted inside the cardboard carton, removing the full carton from the compactor can be quite difficult. The compaction cycle applies a good deal of force to the trash in the carton, causing the carton sides to expand out and against the side walls of the compactor unit such that the carton is firmly wedged in the unit. Without a way to relieve the pressure of the compactor unit walls against the carton, removal of the carton is difficult and can result in tearing the carton and spilling the trash.

One attempted solution has been to create a false wall in the compactor unit using a hydraulic side wall actuator. However, hydraulic functions can be expensive, may not be available, can add weight to the overall compactor unit (particularly undesirable for an aircraft), and are subject to malfunction and expensive repairs.

One technique used in on-ground, household trash compactors, includes a metal frame with an over-center clamp that holds the frame together, and that is then released to remove the compacted trash. This method requires a metal frame that would add weight and complexity to the aircraft operations, and is thus not optimal.

Accordingly, alternate solutions are necessary. Embodiments described herein offer ease of use, weight savings, and eliminate the potential for leaking hydraulic fluid.

### BRIEF SUMMARY

Embodiments of the present invention provide a trash compactor, comprising a first side wall, a back wall, a second side wall, and a front door; a movable wall positioned adjacent to the first side wall, the movable wall configured to move from a first position to a second position, wherein the first position is closer to the first side wall than the second position (and created a gap between the side wall and the movable wall); and a mechanical positioning feature, wherein closure of the front door causes the movable wall to move from the first position to the second position by activation of the positioning feature.

In a specific embodiment, the positioning feature is an inclined ramp or slope portion on the first side wall that cooperates with a roller on the movable wall. Closure of the front door causes the movable wall to move backward and inward, creating a gap. After compaction of the trash, the front door is opened, and the movable wall slides back down the ramp to its rest position and a gap between the carton trash box and the movable wall is created, allowing release of pressure from the trash carton for an easier removal.

### BRIEF DESCRIPTION OF THE DRAWINGS

FIG. 1 shows a top perspective view of one embodiment of a trash compactor, with the front door open and the movable wall adjacent a side wall.

FIG. 2 shows a top perspective view of the trash compactor of FIG. 1, with the front door closed and a gap between the side wall and the movable wall.

FIG. 3 shows a side perspective view of an interior of a trash compactor having the movable wall rotated inwardly.

FIG. 4 shows a close-up of positioning features, the cooperation between which allows movement of the movable wall.

### DETAILED DESCRIPTION

Embodiments of the present invention generally provide a mechanical apparatus and method to move a side platen (as opposed to an electric or hydraulic solution) on the interior of a trash compactor. As a result of not relying on external power for movement, the solution is inherently reliable, less costly, and offers ease of use. The motion of the side platen is a result of the front door motion, and does not require any additional motions from the user or any external power source.

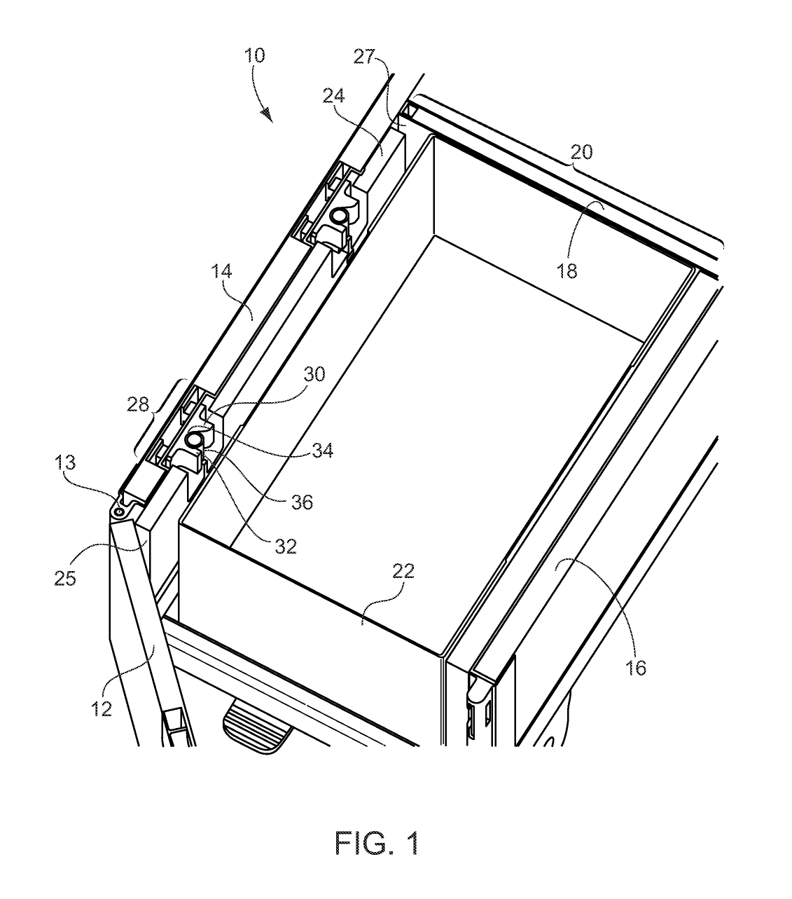

As shown in FIG. 1, the trash compactor 10 features a front door 12, side walls 14, 16, and a rear wall 18. The front door 12 opens and closes along a door hinge 13. These features collectively form a trash compactor cabinet 20. Cabinet 20 is designed to restrain the structural load of the compacted trash. In use, a carton trash box 22 is positioned inside the cabinet 20 and receives trash.

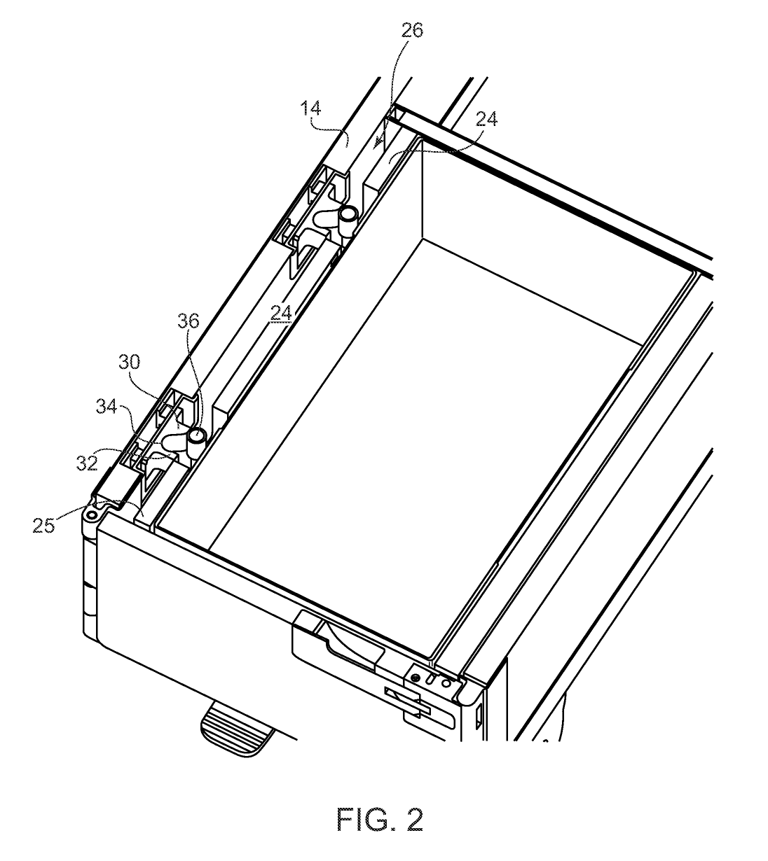

Positioned alongside one of the side walls 14 is a movable wall 24 (which may also be referred to as a side wall platen or a movable side wall). This movable side wall 24 is, in effect, a false wall that is intended to move closer to the carton trash box 22 (and to the opposite side wall 16) when the front door 12 is closed. This closer movement to the carton trash box when 20 when door is closed creates a gap 26 (shown in FIG. 2) between side wall 14 and movable wall 24. The backward movement closes the gap 27 (shown in FIG. 1) between the rear wall 18 and the movable wall 24. In other words, the movable wall 24 has two movement components—backward and inward. As trash is compacted, movable side wall 24 provides the function of a traditional side wall, by providing support for the carton trash box 22 during the compaction process. The carton trash box 22 is urged toward movable side wall 24, the rear wall 18, the other side wall 16, and the front door 12 each time the platen presses down to compress the trash contained therein.

At the end of the compaction cycle(s) and when the front door 12 is opened, movable side wall 24 is allowed to move away from the carton trash box 22 and back toward the side wall 14. This movement closes the gap 26, providing additional space for movement of the compressed carton trash box 22 and releasing its tight compressive state (e.g., it gives the box some “breathing room” to relax from the firm compression). Removing some of the compressive load on the box allows a user to remove the box from the cabinet more easily than without the gap created or otherwise provided by movement of the movable wall.

Non-hydraulic, non-electrical movement of the movable wall 24 may be accomplished by use of a positioning feature 28 to coordinate movement of the movable wall 24 away from the side wall 14 and. In a specific embodiment, the positioning feature 28 may comprise an inclined ramp or slope portion 30 associated with, formed on, or positioned on the side wall 14. This inclined ramp 30 can urge or force the movable wall 24 to move from a first position, close to the side wall 14 (as shown in FIG. 1) to a second position, further away from the side wall 14 and closer to the carton trash box 22 (as shown in FIG. 2).

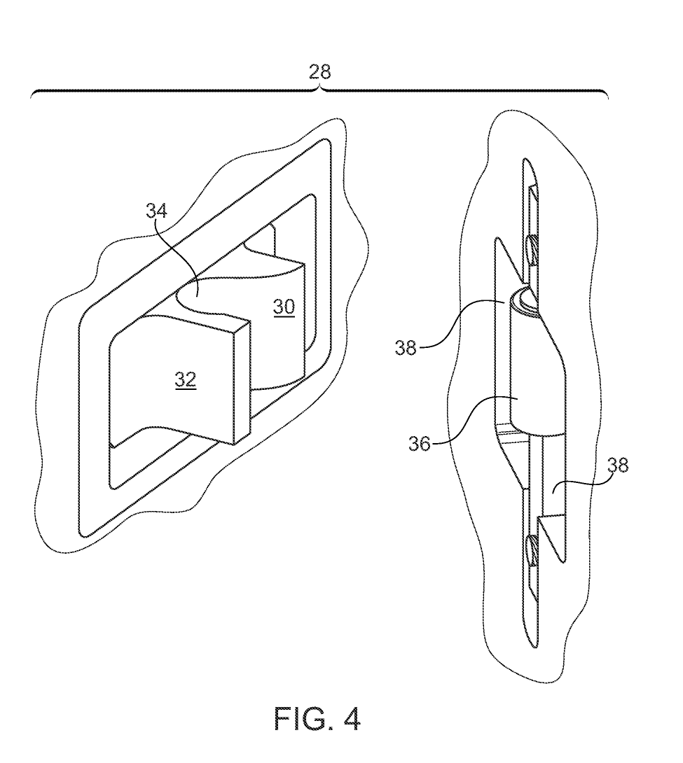

As shown in the close-up of FIG. 4, positioning feature 28 may also have a front stop 32 that is separated from the inclined slope portion 30 by a valley portion 34. Valley portion 34 is configured to receive an articulating feature or roller 36 of the movable wall 24. In one embodiment, the roller 36 is configured to rest in the valley portion 34 when the front door 12 is open (FIG. 1) and articulate toward the rear wall 18 and up the inclined slope 30 when the front door 12 is closed (FIG. 2). Stop portion 32 is configured to provide a halt forward motion of the movable wall when the front door 12 is open.

In the specific embodiments shown, the movement of the main front door 12 closing against a front edge 25 of movable wall 24 pushes against the edge 25 of the movable wall 24, forcing wall 24 back and up the inclined plane or ramp to move the wall 24 inward toward the carton trash box 22. Openings 38 on either side of roller 36 allow clearance for the upper portion of ramp 30 and the stop 32.

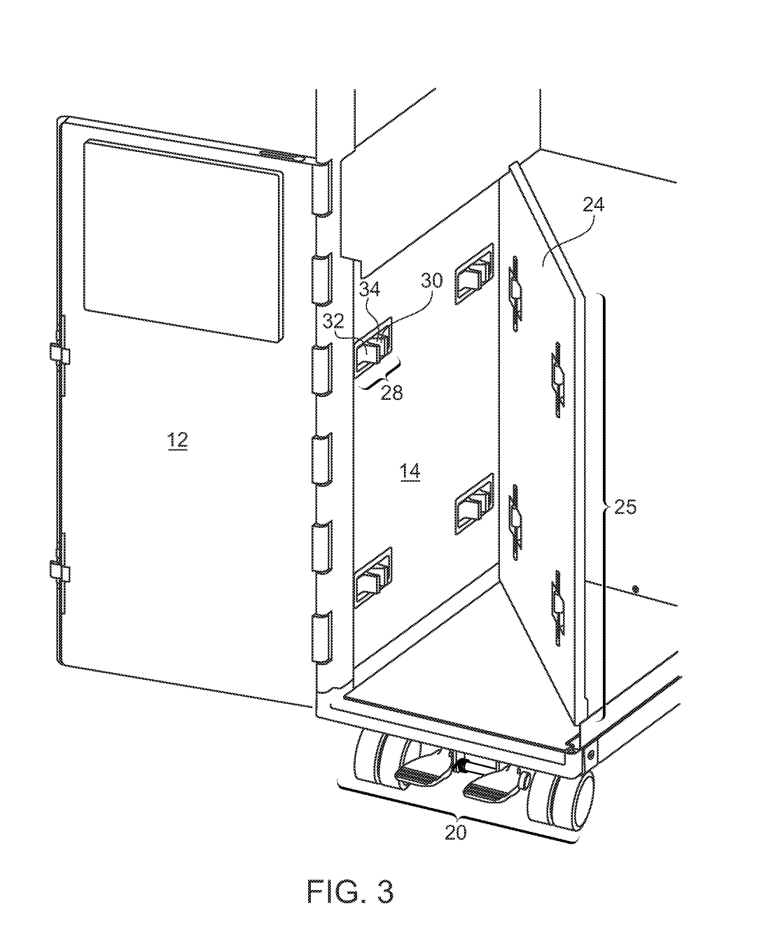

FIG. 3 shows a side view of the trash compactor 10 with the movable wall 24 rotated outwardly for viewing of its features. As shown, the movable wall 24 may have more than one articulating feature or roller 36 in order to ensure its smooth and continuous movement. Four rollers 36 are shown in a square arrangement, but any number of rollers and configuration may be used. It should be understood that the articulating feature could simply be a rod or protrusion that can cooperate with and move along the ramp 30, but it has been found that providing a roller ball 36 provides ease and fluidity of use. FIG. 3 also shows that the side wall 14 may have more than one positioning feature 28. Four positioning features 28 are shown in a square arrangement, but any number of features and configuration may be used. The location of the positioning features 28 and the articulating features 36 should correspond such that they line up when the movable wall 24 is positioned adjacent the side wall 14. It should also be understood that the positioning features 28 and the articulating features 36 may be located on opposite parts. For example, in an alternate embodiment, the side wall 14 may have one or more rollers 36 and the movable wall 24 may have one or more ramps, simply configured differently so that the movable wall 24 still moves toward the trash carton when the front door is closed.

In use, once the front door 12 is closed and the movable wall 24 has moved to the second position in order to create a gap 26, the trash compactor 10 is ready to receive and compact trash. Movement of movable wall 24 includes both a backward motion (toward rear wall 18), as well as inward motion (toward carton trash box 22). The roller 36 cooperates at an upper portion of ramp during compaction. This configuration is shown in FIG. 2. Upon the completion of all compaction cycles, the front door 12 is opened, which releases moveable wall 24 and allows it to roll or articulate back down ramp 30, with roller(s) 36 resting in valley portion(s) 34. This allows the user to more easily remove the trash bin carton 20 for its final disposal and to insert a new carton for the next use.

It should be understood that the height of the ramp 30 is what determines the size of the gap created, and any desired gas or height may be used. In a specific embodiment, the gaps 26, 27 created are between about 1.5 inches to about 2 inches. In a more particular embodiment, the gaps are about ¾ inch in length/width.

Changes and modifications, additions and deletions may be made to the structures and methods recited above and shown in the drawings without departing from the scope or spirit of the invention and the following claims.

What is claimed is:

1. A trash compactor, comprising:
(a) a first side wall, a back wall, a second side wall, and a front door;
(b) a movable wall positioned adjacent to the first side wall, the movable wall configured to move from a first position to a second position, wherein the first position is closer to the first side wall than the second position;
(c) a mechanical positioning feature, wherein closure of the front door causes the movable wall to move from the first position to the second position by activation of the positioning feature.

2. The trash compactor of claim 1, wherein the positioning feature comprises at least one inclined ramp configured to force the movable wall to move from the first position to the second position.

3. The trash compactor of claim 1, wherein the positioning feature is associated with the first side wall and comprises a front stop and an inclined slope portion separated by a valley portion.

4. The trash compactor of claim 3, wherein the movable wall comprises an articulating feature configured to rest in the valley portion when the front door is open, and that articulates toward the rear wall and up the inclined slope when the front door is closed.

5. The trash compactor of claim 1, wherein the positioning features comprises at least one inclined ramp associated with the first side wall and at least one roller associated with the movable wall, wherein the roller of the movable wall articulates against the inclined ramp when the front door is closed.

6. The trash compactor of claim 1, wherein the positioning feature comprises a rolling feature on the movable wall and an inclined ramp positioned on the first side wall, wherein closure of the front door causes the rolling feature to articulate against the inclined ramp.

7. The trash compactor of claim 1, wherein a gap between the movable wall and the first side wall is created when the front door is closed.

8. The trash compactor of claim 1, wherein movement of the movable wall from the first position to the second position comprises a backward motion toward the rear wall and an inward motion toward the second side wall.

9. The trash compactor of claim 1, wherein the trash compactor in on-board a passenger transport vehicle.

10. A method for compacting trash in a trash compactor, comprising:
(a) providing a trash compactor having
(i) a first side wall, a back wall, a second side wall, and a front door;
(ii) a movable wall positioned adjacent to the first side wall, the movable wall configured to move from a first position to a second position, wherein the first position is closer to the first side wall than the second position; and
(iii) a mechanical positioning feature, wherein closure of the front door causes the movable wall to move from the first position to the second position by activation of the positioning feature; and
(b) mechanically activating movement of the movable wall by closing the front door.
